(19) United States
(12) Patent Application Publication
(10) Pub. No.: US 2024/0364627 A1
(43) Pub. Date: Oct. 31, 2024

(54) APPROACHES TO SEAMLESSLY PROPAGATE SERVER PROFILES AND ASSOCIATED INTERFACE CONFIGURATIONS TO EXTERNAL MANAGED NETWORK FABRICS IN A DATACENTER

(71) Applicant: DELL PRODUCTS L.P., Round Rock, TX (US)

(72) Inventors: Smruti Ranjan DEBATA, Sunnyvale, CA (US); Patrick BOYD, Austin, TX (US)

(73) Assignee: DELL PRODUCTS L.P., Round Rock, TX (US)

(21) Appl. No.: 18/308,494

(22) Filed: Apr. 27, 2023

(51) Int. Cl. H04L 45/655; H04L 41/0663; H04L 45/00

(52) U.S. Cl. CPC H04L 45/655; H04L 41/0663; H04L 45/66

(57) ABSTRACT

Described herein are embodiments of systems and methods for network fabric setup within and outside of a modular fabric chassis for its sleds such that server profiles and associated interface configurations may be propagated seamlessly to external managed network fabrics in a data center. Once a switch port of a network switch is connected to a NIC interface of a NIC, the NIC receives from the connected switch port of the network switch a packet comprising a fabric manager attribute. The NIC populates a table comprising mappings between NIC interfaces and corresponding fabric manager information and sends the mapping table to a baseboard management controller (BMC). The BMC maintains a fabric manager attribute per interface in a BMC attribute registry for each NIC. Fabric manager information may be seamlessly refreshed from NIC to BMC or other consoles in case of link down or fabric manager swap situations.

### BACKGROUND

### A. Technical Field

The present disclosure relates generally to information handling systems. More particularly, the present disclosure relates to propagating server profiles and associated interface configurations to external managed network fabrics in a data center.

### B. Background

The subject matter discussed in the background section shall not be assumed to be prior art merely as a result of its mention in this background section. Similarly, a problem mentioned in the background section or associated with the subject matter of the background section should not be assumed to have been previously recognized in the prior art. The subject matter in the background section merely represents different approaches, which in and of themselves may also be inventions.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In a network fabric, provisioning and mapping of server, monolithic or modular, associated network interface card (NIC) or Mezzanine (Mezz) card interfaces to its Fabric Manager(s) is a manual operation currently, which is performed after server discovery from management consoles, such as OpenManage Enterprise (OME), Smart Fabric Manager (SFM), etc., since the management consoles are not aware of the same interfaces. NIC/Mezz card has limited or no knowledge of connected switch/IOM ports and its fabric manager to cascade above information further to a Baseboard Management Controller (BMC), an integrated Dell Remote Access Controller (iDRAC), or dependent consoles.

By design, a fabric and its management service may be viewed as a logical entity that can be interchanged or swapped between interconnected switches within the same fabric. Such interchangeability inherently makes it difficult to consider static mapping for one or more NIC interfaces. Unlike some modular fabric chassis, e.g., Dell MX7000, which have their internal fabric manger, some consoles, e.g., OME or SFM, may send adding or update requests for server profiles and interface configurations to inappropriate or wrong fabric manager, therefore may lead to unnecessary fabric downtime, network outage issues, and security holes.

Accordingly, it is highly desirable to find new, more efficient ways to seamlessly propagate server profiles and associated interface configurations to external managed network fabrics in a datacenter.

### BRIEF DESCRIPTION OF THE DRAWINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may not be to scale.

FIG. 1 (“FIG. 1”) depicts network fabric setup within and outside of a modular fabric chassis for its internal consoles, according to embodiments of the present disclosure.

FIG. 2 depicts a process for seamless propagation of server profile and interface configurations, according to embodiments of the present disclosure.

FIG. 3 depicts a unicast Link Layer Discovery Protocol (LLDP) packet comprising a set of attributes, according to embodiments of the present disclosure.

FIG. 4 depicts a mapping table comprising multiple mappings between NIC interfaces and fabric managers, according to embodiments of the present disclosure.

FIG. 5 depicts a simplified block diagram of an information handling system, according to embodiments of the present disclosure.

FIG. 6 depicts an alternative block diagram of an information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgement, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” “comprising,” and any of their variants shall be understood to be open terms, and any examples or lists of items are provided by way of illustration and shall not be used to limit the scope of this disclosure.

A service, function, or resource is not limited to a single service, function, or resource; usage of these terms may refer to a grouping of related services, functions, or resources, which may be distributed or aggregated. The use of memory, database, information base, data store, tables, hardware, cache, and the like may be used herein to refer to system component or components into which information may be entered or otherwise recorded. The terms “data,” “information,” along with similar terms, may be replaced by other terminologies referring to a group of one or more bits, and may be used interchangeably. The terms “packet” or “frame” shall be understood to mean a group of one or more bits. The term “frame” shall not be interpreted as limiting embodiments of the present invention to Layer 2 networks; and, the term “packet” shall not be interpreted as limiting embodiments of the present invention to Layer 3 networks. The terms “packet,” “frame,” “data,” or “data traffic” may be replaced by other terminologies referring to a group of bits, such as “datagram” or “cell.” The words “optimal,” “optimize,” “optimization,” and the like refer to an improvement of an outcome or a process and do not require that the specified outcome or process has achieved an “optimal” or peak state.

It shall be noted that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

In one or more embodiments, a stop condition may include: (1) a set number of iterations have been performed; (2) an amount of processing time has been reached; (3) convergence (e.g., the difference between consecutive iterations is less than a first threshold value); (4) divergence (e.g., the performance deteriorates); and (5) an acceptable outcome has been reached.

It shall be noted that any experiments and results provided herein are provided by way of illustration and were performed under specific conditions using a specific embodiment or embodiments; accordingly, neither these experiments nor their results shall be used to limit the scope of the disclosure of the current patent document.

### A. Introduction

In a network fabric, management consoles, such as OpenManage Enterprise (OME), Smart Fabric Manager (SFM), etc., perform server discovery and get network interface card (NIC) or Mezzanine (Mezz) card interfaces and their configurations. Such information needs to be propagated to respective Fabric Managers (FMs), which may be chassis managed as an internal Fabric Manager Service for a modular fabric chassis, e.g., Dell MX7000, or as an external service, such as for a Dell Z9432 network switch.

In certain circumstances, a modular fabric chassis, such as Dell MX7000, may be unaware of an external fabric, which may be created by an external network switch (such as a Dell Z9432 network switch). The external network switch performs routing of host traffic for internal sleds that are attached to chassis slots of the modular fabric chassis and connected via one or more spinner IO module(s) associated to the modular fabric chassis.

Provisioning and mapping of server, monolithic or modular, associated NIC/Mezz card interfaces to its FMs is a manual operation currently, which is performed after server discovery from management consoles, such as OME, SFM, etc., since the management consoles are not aware of the same interfaces. NIC/Mezz card has limited or no knowledge of connected switch/IOM ports and its fabric manager to cascade above information further to a BMC, an iDRAC, or dependent consoles. By design, a fabric and its management service may be viewed as a logical entity that can be interchanged or swapped between interconnected switches within the same fabric. Such interchangeability inherently makes it difficult to consider static mapping for one or more NIC interfaces. Unlike some modular fabric chassis, e.g., Dell MX7000, which has its internal fabric manager, some consoles, e.g., OME or SFM, may send adding or update requests for server profiles and interface configurations to inappropriate or wrong fabric manager, therefore, may lead to unnecessary fabric downtime, network outage issues, and security holes.

Described herein are embodiments of systems and methods for network fabric setup within and outside of a modular fabric chassis for its sleds such that server profiles and associated interface configurations may be propagated seamlessly to external managed network fabrics in a datacenter. The phrase “network switch” as used herein shall be construed to mean an information handling system that processes data (e.g., compute, calculate, determine, classify, process, transmit, receive, retrieve, originate, route, switch, store, display, communicate, manifest, detect, record, reproduce, handle, or utilize any form of information, intelligence, or data) and is not limited to devices that perform only switching in a network setting; such an information handling system may perform switching functions, routing functions, other functions, or any combination thereof.

### B. Embodiments of Network Fabric Setup

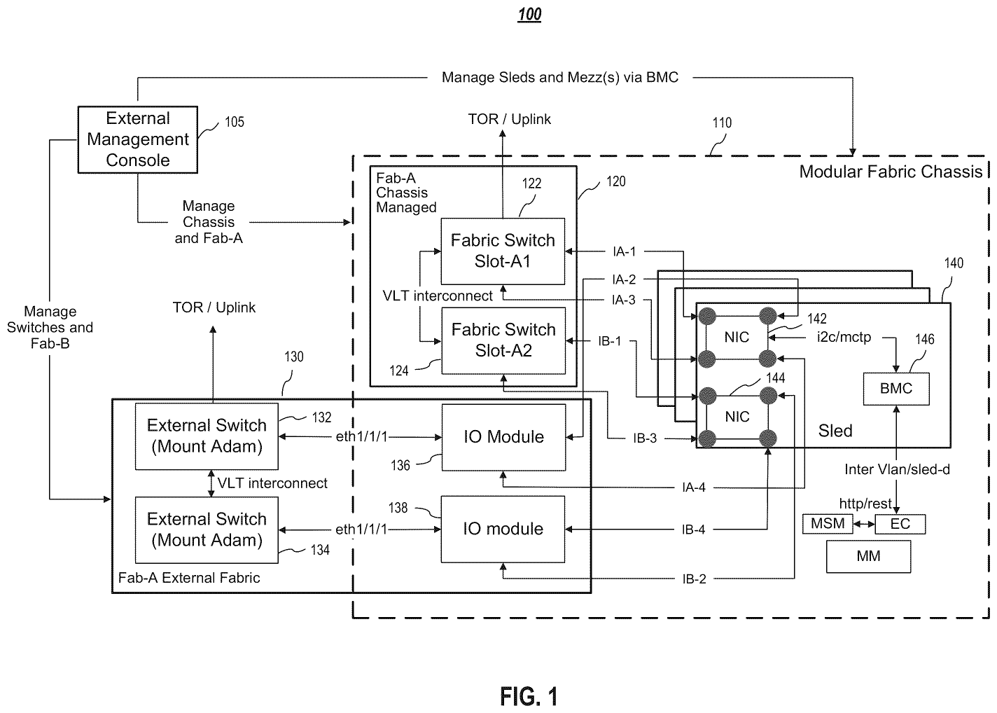

FIG. 1 depicts a network fabric setup with port-switch connections for fabrics internal and external to a module fabric chassis, according to embodiments of the present disclosure. As shown in FIG. 1, the module fabric chassis 110, e.g., Dell PowerEdge MX7000 Modular Chassis, comprises an internal fabric 120 and at least an internal console 140. The internal fabric 120 comprises a first fabric switch 122 and a second fabric switch 124, with both switches connected via a Virtual Link Trunking (VLT) interconnection. The internal console 140 comprises a first NIC 142 and a second NIC 144, with each NIC comprising multiple ports for switch connections. The internal console 140 may be a compute sled server for various services, such as virtualization, software-defined storage, Hyperconverged Infrastructure (HCI), and/or big data. The module fabric chassis 110 further comprises a first input-output (IO) module 136 and a second IO module 138, which may be respectively connected via Ethernet connection to a first external switch 132 and a second external switch 134, such as Dell z9432 network switches. The IO modules 136/138 and the external switches 132/134 may form an external fabric 130.

The external fabric 130 and the internal fabric 120 may both couple to an external management console 105, such as Dell OpenManage Enterprise (OME), OpenManage Enterprise Modular (OME-M), or a Smart Fabric Manager (SFM), etc. The management console 105 may provide comprehensive management of servers, chassis, storage, and/or network switches in the module fabric chassis 110 and the external fabric 130.

As shown in the exemplary embodiment in FIG. 1, the first NIC 142 in the internal console 140 comprises four ports for connections to the first fabric switch 122, the first IO module 136, the second fabric switch 124, and the second IO module 138 via links 1A-1, 1A-2, 1A-3, and 1A-4, respectively, such the first NIC 142 may have a separate link to each fabric switch/IO module. The second NIC 144 in the internal console 140 comprises four ports for connections to the first fabric switch 122, the first IO module 136, the second fabric switch 124, and the second IO module 138 via links 1B-1, 1B-2, 1B-3, and 1B-4, respectively, such the second NIC 144 may also have a separate link to each fabric switch/IO module.

In one or more embodiments, the first NIC 142 or the second NIC 144 may couple to a baseboard management controller (BMC) 146 via a communication channel, e.g., an Inter-Integrated Circuit (I2C) channel or a Management Component Transport Protocol (MCTP) channel. The BMC 146 allows remote, out-of-band LAN and/or serial port power control, event log access, and console redirection for remote monitoring and management of a host system. In one or more embodiments, the BMC 146 may be an integrated Dell Remote Access Controller (iDRAC), which is designed for secure local and remote server management and helps IT administrators deploy, update and monitor servers.

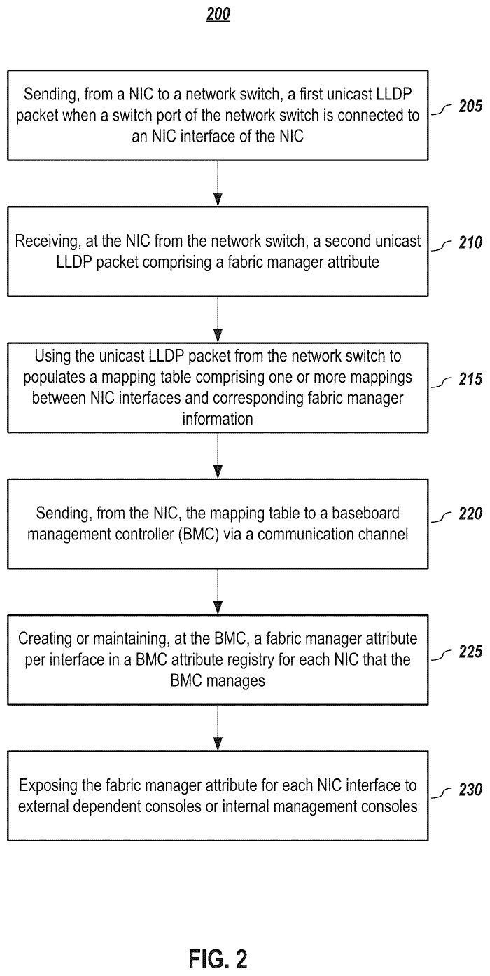

FIG. 2 depicts a process for seamless propagation of server profile and interface configurations with respect to the network fabric setup shown in FIG. 1, according to embodiments of the present disclosure. In step 205, when a switch port of a network switch (e.g., the first fabric switch 122) is connected via a link (e.g., 1A-1) to a NIC interface of the NIC (e.g., the first NIC 142), the NIC sends to the network switch a first unicast Link Layer Discovery Protocol (LLDP) packet comprising a set of attributes, such as a NIC port MAC address, a NIC port description, a system description, NIC port or NIC capabilities, time-to-live (TTL), etc., of the NIC interface and the NIC.

In step 210, the NIC receives, from the connected switch port of the network switch, a second unicast LLDP packet comprising a fabric manager attribute, presented as a type-length-value (TLV) addition, besides other information, such as a switch port ID, a system type (e.g., Mx9116n, z9432, etc.) for the network switch, switch port MAC address, version, etc. It shall be noted that the switch port may connect to the NIC directly or via the IO module or other passthrough.

TABLE 1
Exemplary TLV addition to LLDP packet

| | Field | Field Length | Description |
|---|---|---|---|
| TLV Header | TLV type | 7 bits | 127 |
| TLV Length | 10 bits | 50 bits | |
| TLV Information string | 802.1 OUI | 3 octets | Dell OUI: F88156 |
| Sub-type | 1 octet | 26 | Present Fabric |
| Fabric-Mgr | 8 Octets × 10 | Contain Fabric Manager | Manager Service |
| | | destination MAC address | Host |
| | | and service tag of current | |
| | | switch which is hosting | |
| | | fabric manager service | |
| | | Sample value: | |
| | | mac-id: 22:EC:4f:3C:2f | |
| | | svgtag: CC3R2CA | |
| | | Bits and bytes of | |
| | | information are added as | |
| | | and when required | |

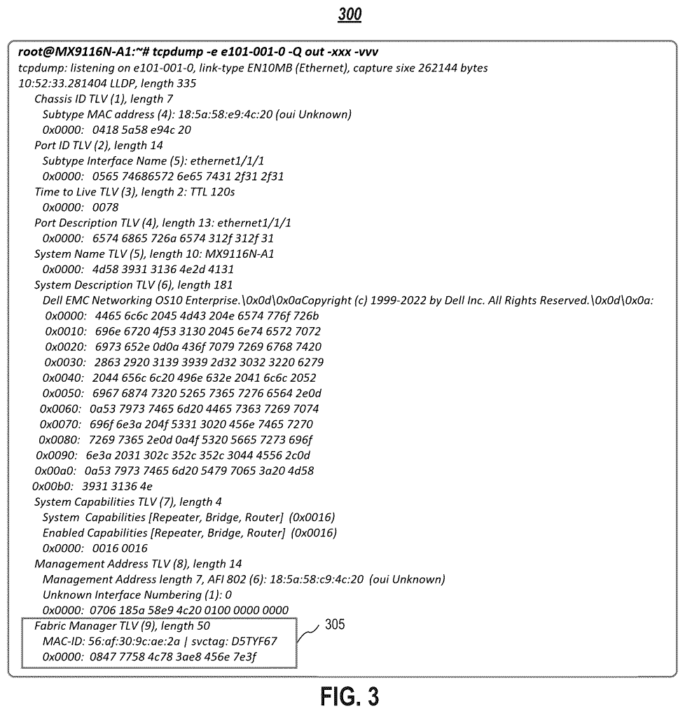

Table 1 shows an exemplary TLV additional to a unicast LLDP packet sent from a network switch. The TLV addition comprises fabric manager information, such as a fabric manager destination MAC address and service tag of a current switch hosting fabric manager service. FIG. 3 depicts an exemplary LLDP packet sent from a network switch, according to embodiments of the present disclosure. The exemplary LLDP packet comprises a set of attributes, including a specific fabric manager attribute 305, shown as the Fabric Manager TLV(9) in FIG. 3.

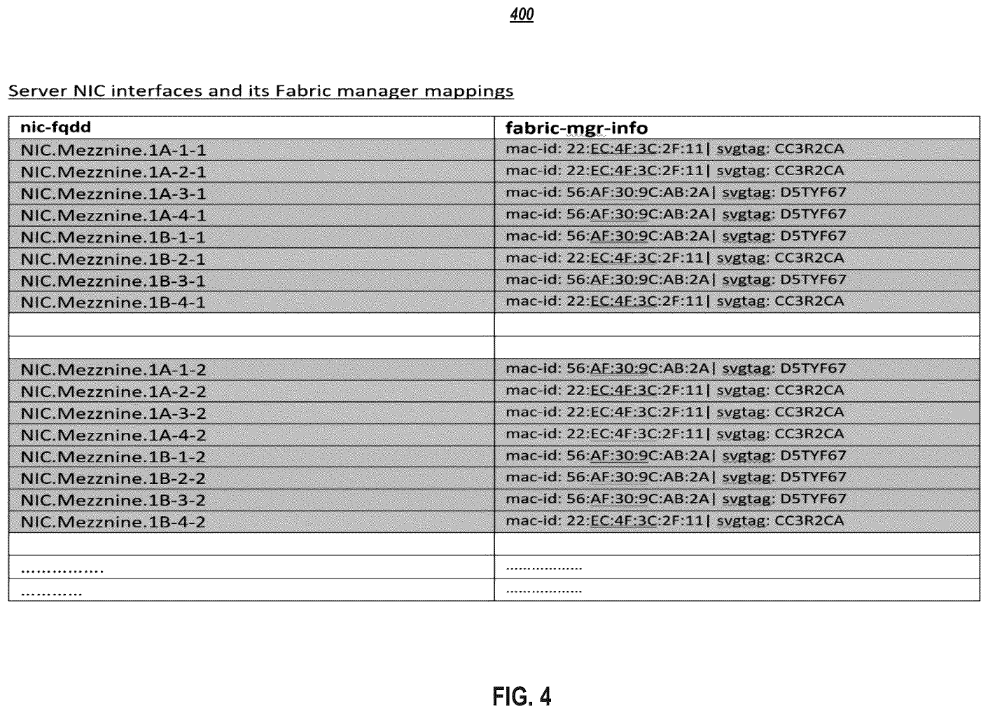

In step 215, the NIC uses the unicast LLDP packet from the network switch to populate a table comprising one or more mappings between NIC interfaces and corresponding fabric manager information. FIG. 4 depicts a mapping table comprising multiple mappings between NIC interfaces and fabric managers, according to embodiments of the present disclosure. Each mapping in FIG. 4 corresponds to a NIC fully qualified device descriptor (fqdd) to a fabrics manager information (fabric-mgr-info) entry, which comprises a MAC address (MAC-ID) and a service tag (svgtag) for a corresponding fabrics manager.

In one or more embodiments, the mapping table may be refreshed or updated at the NIC when the NIC receives one LLDP packet from one of multiple NIC interfaces. As shown in FIG. 1, the NIC 142 has four NIC interfaces and thus may receive four LLDP packets. Therefore, the NIC 142 may update or refresh the mapping table multiple times until corresponding LLDP packets are received from all four NIC interfaces.

In one or more embodiments, when a fabric manager is offline or a link between the NIC and one network switch is down, the NIC may empty the mapping table after a defined time window or threshold, which may be configurable. The NIC may repeat steps 205, 210, and 215 to re-send a first LLDP packet, re-receive a second unicast LLDP packet, and re-populate a mapping table.

In step 220, the NIC sends the mapping table to a baseboard management controller (BMC) via a communication channel, e.g., an Inter-Integrated Circuit (I2C) channel or a Management Component Transport Protocol (MCTP) channel. The NIC may send the mapping table periodically or in real-time when the NIC identifies a change in the mappings.

In step 225, the BMC creates or maintains a fabric manager attribute per interface in a BMC attribute registry for each NIC that the BMC manages. The BMC may perform a periodic update as it receives mapping tables from existing or newly added NIC interfaces.

In step 230, the BMC exposes the fabric manager attribute for each NIC interface to external dependent consoles (e.g., OME, SFM, etc.) or the internal management console of the module fabric chassis via various communication channels or protocols, such as Hypertext Transfer Protocol (HTTP) or redfish. Furthermore, the external consoles or the modular chassis may fetch the mappings from the BMC to retrieve an appropriate fabric manager and propagate server profile and interface configurations accordingly for external or internal fabrics within the chassis.

In one or more embodiments, when an internal or external fabric has a new fabric manager due to management change or swap, one network switch managed by the new fabric manager may re-initiate a new unicast LLDP packet comprising a new fabric manager attribute regarding the new fabric manager.

In one or more embodiments, the modular fabric chassis may initiate an Open Authorization (OAuth) request to an external fabric manager before sending any server profile and interface configurations. For dependent or internal consoles, e.g., OME or SFM, such an OAuth may not be applicable as the modular fabric chassis may discover them during discovery.

In one or more embodiments, mappings between NIC interfaces and fabric managers may be automatically updated. Health or inventory service may be leveraged from dependent/internal consoles or the modular fabric chassis, e.g., the Dell MX7000 chassis, to fetch fabric mangers information across discovered BMC(s) for auto-update implementation.

### C. System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smart phone, phablet, tablet, etc.), smart watch, server (e.g., blade server or rack server), a network storage device, camera, or any other suitable device and may vary in size, shape, performance, functionality, and price. The computing system may include random access memory (RAM), one or more processing resources such as a central processing/processor unit (CPU) or hardware or software control logic, read-only memory (ROM), and/or other types of memory. Additional components of the computing system may include one or more drives (e.g., hard disk drives, solid state drive, or both), one or more network ports for communicating with external devices as well as various input and/or output (I/O) devices. The computing system may also include one or more buses operable to transmit communications between the various hardware components.

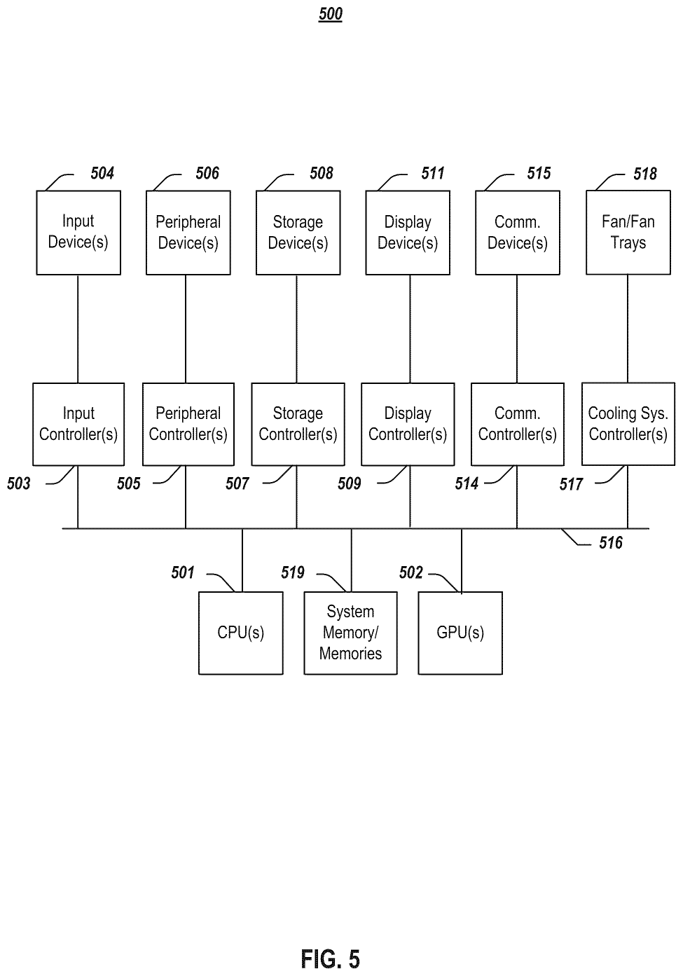

FIG. 5 depicts a simplified block diagram of an information handling system (or computing system), according to embodiments of the present disclosure. It will be understood that the functionalities shown for system 500 may operate to support various embodiments of a computing system—although it shall be understood that a computing system may be differently configured and include different components, including having fewer or more components as depicted in FIG. 5.

As illustrated in FIG. 5, the computing system 500 includes one or more CPUs 501 that provides computing resources and controls the computer. CPU 501 may be implemented with a microprocessor or the like and may also include one or more graphics processing units (GPU) 502 and/or a floating-point coprocessor for mathematical computations. In one or more embodiments, one or more GPUs 502 may be incorporated within the display controller 509, such as part of a graphics card or cards. The system 500 may also include a system memory 519, which may comprise RAM, ROM, or both.

A number of controllers and peripheral devices may also be provided, as shown in FIG. 5. An input controller 503 represents an interface to various input device(s) 504, such as a keyboard, mouse, touchscreen, stylus, microphone, camera, trackpad, display, etc. The computing system 500 may also include a storage controller 507 for interfacing with one or more storage devices 508 each of which includes a storage medium such as magnetic tape or disk, or an optical medium that might be used to record programs of instructions for operating systems, utilities, and applications, which may include embodiments of programs that implement various aspects of the present disclosure. Storage device(s) 508 may also be used to store processed data or data to be processed in accordance with the disclosure. The system 500 may also include a display controller 509 for providing an interface to a display device 511, which may be a cathode ray tube (CRT) display, a thin film transistor (TFT) display, organic light-emitting diode, electroluminescent panel, plasma panel, or any other type of display. The computing system 500 may also include one or more peripheral controllers or interfaces 505 for one or more peripherals 506. Examples of peripherals may include one or more printers, scanners, input devices, output devices, sensors, and the like. A communications controller 514 may interface with one or more communication devices 515, which enables the system 500 to connect to remote devices through any of a variety of networks including the Internet, a cloud resource (e.g., an Ethernet cloud, a Fibre Channel over Ethernet (FCOE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 500 comprises one or more fans or fan trays 518 and a cooling subsystem controller or controllers 517 that monitors thermal temperature(s) of the system 500 (or components thereof) and operates the fans/fan trays 518 to help regulate the temperature.

In the illustrated system, all major system components may connect to a bus 516, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

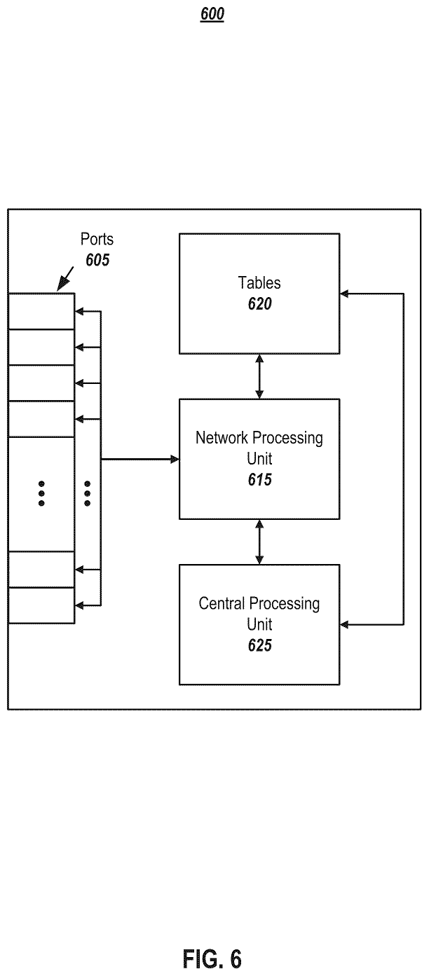

FIG. 6 depicts an alternative block diagram of an information handling system, according to embodiments of the present disclosure. It will be understood that the functionalities shown for system 600 may operate to support various embodiments of the present disclosure—although it shall be understood that such system may be differently configured and include different components, additional components, or fewer components.

The information handling system 600 may include a plurality of I/O ports 605, a network processing unit (NPU) 615, one or more tables 620, and a CPU 625. The system includes a power supply (not shown) and may also include other components, which are not shown for sake of simplicity.

In one or more embodiments, the I/O ports 605 may be connected via one or more cables to one or more other network devices or clients. The network processing unit 615 may use information included in the network data received at the node 600, as well as information stored in the tables 620, to identify a next device for the network data, among other possible activities. In one or more embodiments, a switching fabric may then schedule the network data for propagation through the node to an egress port for transmission to the next destination.

Aspects of the present disclosure may be encoded upon one or more non-transitory computer-readable media with instructions for one or more processors or processing units to cause steps to be performed. It shall be noted that the one or more non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that have computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as compact discs (CDs) and holographic devices; magneto-optical media; and hardware devices that are specially configured to store or to store and execute program code, such as ASICs, PLDs, flash memory devices, other non-volatile memory devices (such as 3D XPoint-based devices), ROM, and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A processor-implemented method comprising:
sending, from a network interface card (NIC) to a switch port of a network switch, a first packet when the switch port is connected to a NIC interface of the NIC, the first packet comprises a set of attributes of the NIC interface;
receiving, at the NIC from the network switch, a second packet that comprises a fabric manager attribute regarding a fabric manager of a fabric network to which the network switch belongs;
populating, at the NIC, a mapping table comprising one or more mappings between NIC interfaces and corresponding fabric manager information using the received second packet; and
sending, from the NIC to a baseboard management controller (BMC), the mapping table via a communication channel.

2. The processor-implemented method of claim 1 wherein the first packet and the second packet are unicast Link Layer Discovery Protocol (LLDP) packets.

3. The processor-implemented method of claim 2 wherein the fabric manager attribute is a type-length-value (TLV) addition comprising one or more of:
a fabric manager destination MAC address; and
a service tag of a current switch hosting fabric manager service.

4. The processor-implemented method of claim 1 wherein:
responsive to a threshold time expiring after a fabric manager is offline or a link between the NIC and one network switch is down:
emptying, at the NIC, the mapping table;
re-sending from one or more NIC interfaces at the NIC to one or more connected network switches the first packet;
re-receiving, at the NIC from the one or more connected network switches, one or more packets comprising fabric manager attributes; and
re-populating, at the NIC, the mapping table using the fabric manager attributes.

5. The processor-implemented method of claim 1 further comprising:
maintaining, at the BMC, a fabric manager attribute per NIC interface in a BMC attribute registry for each NIC that the BMC manages.

6. The processor-implemented method of claim 4 further comprising:
exposing the fabric manager attribute per NIC interface to external dependent consoles or internal management consoles.

7. The processor-implemented method of claim 5 wherein:
prior to allowing an external dependent console accessing the fabric manager attribute per NIC interface at the BMC, requesting an Open Authorization (OAuth).

8. The processor-implemented method of claim 1 wherein the switch port is connected to the NIC interface of the NIC directly or via an input-output (IO) module.

9. The processor-implemented method of claim 4 wherein the step of sending from the BMC to a management console the mapping table comprises:
sending from the BMC to the management console the mapping table as part of an auto-update process.

10. A non-transitory computer-readable medium or media comprising one or more sequences of instructions which, when executed by at least one processor, causes steps to be performed comprising:
sending, from a network interface card (NIC) to a switch port of a network switch, a first packet when the switch port is connected to a NIC interface of the NIC, the first packet comprises a set of attributes of the NIC interface;
receiving, at the NIC from the network switch, a second packet that comprises a fabric manager attribute regarding a fabric manager of a fabric network to which the network switch belongs;
populating, at the NIC, a mapping table comprising one or more mappings between NIC interfaces and corresponding fabric manager information using the received second packet; and
sending, from the NIC to a baseboard management controller (BMC), the mapping table via a communication channel.

11. The non-transitory computer-readable medium or media of claim 10 wherein the first packet and the second packet are unicast Link Layer Discovery Protocol (LLDP) packets.

12. The non-transitory computer-readable medium or media of claim 11 wherein the fabric manager attribute is a time-length-value (TLV) addition comprising one or more of:
a fabric manager destination MAC address; and
a service tag of a current switch hosting fabric manager service.

13. The non-transitory computer-readable medium or media of claim 10 wherein the steps further comprising:
responsive to a threshold time expiring after a fabric manager is offline or a link between the NIC and one network switch is down:
emptying, at the NIC, the mapping table;
re-sending from one or more NIC interfaces at the NIC to one or more connected network switches the first packet;
re-receiving, at the NIC from the one or more connected network switches, one or more packets comprising fabric manager attributes; and
re-populating, at the NIC, the mapping table using the fabric manager attributes.

14. The non-transitory computer-readable medium or media of claim 10 wherein the steps further comprising:
maintaining, at the BMC, a fabric manager attribute per NIC interface in a BMC attribute registry for each NIC that the BMC manages.

15. The non-transitory computer-readable medium or media of claim 14 wherein the fabric manager attribute per NIC interface is exposed to external dependent consoles or internal management consoles.

16. The non-transitory computer-readable medium or media of claim 15 wherein prior to allowing an external dependent console accessing the fabric manager attribute per NIC interface at the BMC, an Open Authorization (OAuth) is requested.

17. A system for profile propagation comprising:
a network interface card (NIC) comprising one or more NIC interfaces, the NIC is configured for:
when one NIC interface of the NIC is connected to a switch port of a network switch, sending a first packet comprising a set of attributes of the NIC interface to the network switch;
receiving from the network switch a second packet that comprises a fabric manager attribute regarding a fabric manager of a fabric network to which the network switch belongs;
populating a mapping table comprising one or more mappings between the one or more NIC interfaces and corresponding fabric managers using the second packet; and
sending, via a communication channel, the mapping table to a baseboard management controller (BMC).

18. The system of claim 17 wherein the first packet and the second packet are unicast Link Layer Discovery Protocol (LLDP) packets.

19. The system of claim 17 wherein the fabric manager attribute is a time-length-value (TLV) addition comprising one or more of:
a fabric manager destination MAC address; and
a service tag of a current switch hosting fabric manager service.

20. The system of claim 17 wherein the NIC is further configured for:
responsive to a threshold time expiring after a fabric manager is offline or a link between the NIC and one network switch is down:
emptying the mapping table;
re-sending the first packet to one or more connected network switches;
re-receiving one or more packets comprising fabric manager attributes from the one or more connected network switches; and
re-populating the mapping table using the fabric manager attributes.
